(19) United States
(12) Patent Application Publication
(10) Pub. No.: US 2010/0089957 A1
(43) Pub. Date: Apr. 15, 2010

(54) Baggage carrier configuration for a vehicle rear

(75) Inventor: Armin BARTH, Lonsheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/557,292

(22) Filed: Sep. 10, 2009

(30) Foreign Application Priority Data
Sep. 10, 2008 (DE) 102008046574.7

(51) Int. Cl. B60R 11/00

(52) U.S. Cl. 224/497; 224/539

(57) ABSTRACT

A baggage carrier configuration is provided for a vehicle rear having a carrier, which is permanently connected to the vehicle and is movable relative to the vehicle rear from a nonusage position into a usage position, which extends further away from the vehicle rear. At least one object of the present invention is the provision of a baggage carrier configuration, in which a carrier, which is permanently connected to the vehicle and is movable back-and-forth between a nonusage position and a usage position, automatically allows the operation of a vehicle environmental detector and/or a parking aid in the usage position. For this purpose, at least one spacing sensor is provided on the carrier and the spacing sensor is activated in the usage position.

### CROSS-REFERENCE TO RELATED APPLICATION

This application claims priority to German Patent Application No. 102008046574.7, filed Sep. 10, 2008, which is incorporated herein by reference in its entirety.

### TECHNICAL FIELD

The invention is in the field of comfort equipment of vehicles, in particular passenger automobiles, and is oriented to so-called parking assistance systems, which are becoming increasingly widespread.

The invention relates to a baggage carrier configuration for a vehicle rear, having a carrier which is permanently connected to the vehicle and is movable relative to the vehicle rear from a non-usage position into a usage position, which extends further away from the vehicle rear.

### BACKGROUND

With increasing mobility and growing demands on the flexibility of vehicles, in particular on the transport and cargo capabilities of passenger automobiles, systems, using which objects may be transported outside the passenger compartment, have become known and increasingly popular. In addition to the classical roof baggage carriers, various types of rear baggage carriers have become known in more recent time, which are used in particular for transporting bicycles.

The uncomplicated carrying of one or more bicycles, such as road bicycles or mountain bikes, is increasingly becoming a decisive element of the purchase and/or usage decision among vehicle users.

A baggage carrier configuration for a vehicle rear of the types cited at the beginning is disclosed in German Published Application DE 43 40 009 A1 and comprises a part mounted fixed on the vehicle frame and a part movable relative thereto. In the usage position, a rear railing, which is connected to the second part, of the transport carrier can be folded up and locked, a separate rear light being folded out simultaneously.

The second part is used in this usage position as a transport plane and thus as the actual carrier for one or more bicycles and is displaceable back-and-forth relative to the part mounted fixed on the frame using telescopic guides or guide rails, for example, essentially in the vehicle longitudinal direction between a nonusage position and the usage position. This has the advantage that the second part is available very rapidly as needed as a part which is always carried and as the actual carrier. In addition, the second part—in contrast to dismountable rear baggage carriers or roof baggage carriers upon nonusage in the dismounted state—does not occupy additional storage space as a separate part, for example, where it must additionally be placed.

The problem of the maneuvering and reverse parking of the vehicle, which is made more difficult by the bicycles located on the carrier in the usage position, is not discussed in DE 43 40 009 A1.

In regard to the parking assistance systems, which were described at the beginning and are increasingly widespread and popular, a system for registering the vehicle surroundings is known from DE 102 30 303 A1, which registers the nonvisible vicinity of the vehicle and can notify the driver of an impending collision with objects or other vehicles early by outputting a signal. This system allows an asymmetrical configuration of the distance warning devices or spacing sensors, in order to be able to attach elements to be fastened subsequently to the vehicle, such as baggage carriers or the like, without having to interfere with the sensor position predetermined upon asymmetrical distribution of the sensors. However, DE 102 30 303 A1 is only directed to holders or carriers attached later to the vehicle, which remain permanently in their usage position, as long as they are connected to the vehicle and/or are attached thereon.

International Patent Application WO 2006/043050 A1 describes a container system, which can be mounted fixedly on a vehicle frame at the factory or subsequently, and which can also function as a bicycle rear carrier, in that its lateral container walls are provided with retaining clamps for bicycles. The container system is mounted on the lower rear area of the vehicle such that a cargo hatch can be opened unobstructed. The container system can be provided with a bumper, in which spacing sensors are integrated.

Before this background, the object of the present invention is to provide a baggage carrier configuration for a vehicle rear, in which a carrier, which is permanently connected to the vehicle and is movable back-and-forth between a nonusage position and a usage position, automatically allows the operation of a vehicle environment detector and/or a parking aid in the usage position.

### SUMMARY

It is accordingly provided that at least one spacing sensor is provided on the carrier, and the spacing sensor is activated in the usage position.

The invention thus allows a particularly comfortable rear transport capability, which is ready for operation rapidly at any time, in particular for bicycles, a parking assistance system being able to act reliably in particular in this configuration, which is particularly critical and unclear due to the rear transport material, in that the spacing sensors provided in the carrier are activated in the usage position.

The spacing sensors may be attached and contacted on the carrier with comparatively simple manufacturing, because corresponding cable sets are typically laid therein, for example, because of the required equipment with rear vehicle lights.

The invention can fundamentally already be implemented with a single spacing sensor. Particularly good resolution of the rear near field may be implemented by the use of multiple spacing sensors. Multiple spacing sensors are thus described hereafter in connection with the invention, without the invention being limited thereto, however.

Further advantages, designs, and aspects of the invention result from the subclaims, the following description, and the drawing.

In regard to the configuration of the spacing sensors, a preferred design of the invention provides that the spacing sensors are situated on rear lights which can be folded out.

According to a preferred refinement of the invention, the vehicle rear itself is equipped with further rear spacing sensors, which are deactivated in the usage position of the carrier. The vehicle then also has a conventional environmental sensor unit available, which acts in a way known per se in the normal configuration of the vehicle, when the carrier is inactive, i.e., located in the nonusage position.

Furthermore, it can be provided that spacing sensors provided on the carrier are deactivated in the nonusage position. In a particularly advantageous way, a design of the parking assistance system which adapts itself automatically to the particular rear baggage carrier configuration is implemented. Specifically, it is thus ensured automatically as a function of the position of the rear baggage carrier which sensors are active. The driver thus reliably receives information and/or signals about the rear vehicle environment in any case—i.e., also in the “normal case” without the rear baggage carrier in operation—using optimally positioned sensors.

Therefore, so-called flexible carrier systems—which are also identified by the keyword “flex-fix carrier systems”—may advantageously be implemented in a twofold system adaptation, mainly for the operating state “retracted rear baggage carrier” and the operating state “extended rear baggage carrier”.

The deactivatable rear spacing sensors are preferably situated in the area of a rear license plate carrier and thus provide the familiar uniform coverage of the rear vehicle area to a parking assistance system.

The spacing sensors provided in the area of the rear license plate are particularly preferably movable with the carrier into the usage position; the sensors are thus used for the rear near field monitoring both in the vehicle configuration “retracted rear baggage carrier” and also “extended rear baggage carrier”, while saving further sensors.

In order to recognize the claimed automatic recognition of the operating state—i.e., the nonusage position or the usage position of the carrier—reliably and easily, a position sensor is provided according to a further advantageous design of the invention, which monitors the position of the carrier relative to the vehicle rear. The position sensor signals permit the usage position or nonusage position of the carrier to be recognized, so that the spacing sensors required depending on the configuration may be activated or deactivated automatically.

According to an advantageous refinement of the invention, it is provided that the carrier is movable step-by-step into various usage positions, which are selectable according to the transport material. The rear baggage carrier can thus be extended in multiple steps, for example, one bicycle having sufficient transport space per step.

### BRIEF DESCRIPTION OF THE DRAWINGS

The present invention will hereinafter be described in conjunction with the following drawing figures, wherein like numerals denote like elements, and:

FIG. 1 shows a vehicle rear having a configuration according to the an embodiment of the invention, a carrier being located in the nonusage position; and

FIG. 2 shows a vehicle rear having a carrier located in the usage position.

### DETAILED DESCRIPTION

The following detailed description is merely exemplary in nature and is not intended to limit application and uses. Furthermore, there is no intention to be bound by any theory presented in the preceding background or summary or the following detailed description.

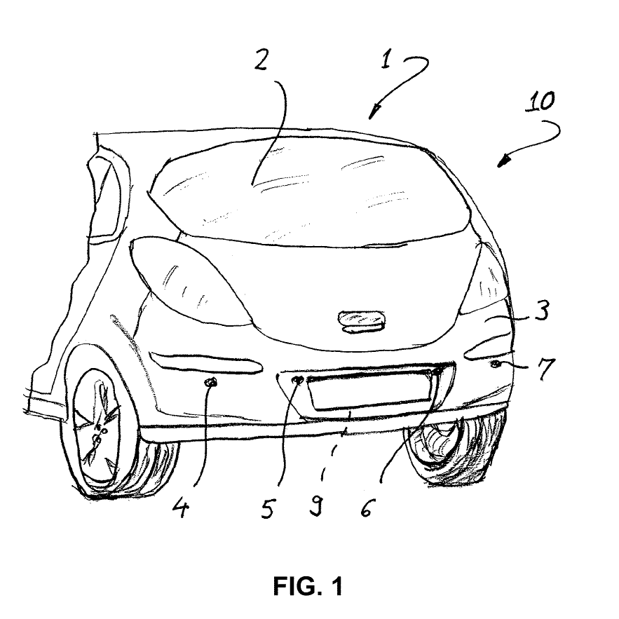

FIG. 1 shows a vehicle rear 1, which is provided in a known way with a rear hatch 2. Multiple rear spacing sensors 4, 5, 6, 7 are provided in the bumper extending below the rear hatch, which provide signals representing the distance to objects and/or other vehicles in a way known per se, which are prepared for the driver by an analysis unit. The spacing situation can be conveyed both visually and also acoustically, for example, by a tone which increases in intensity or frequency.

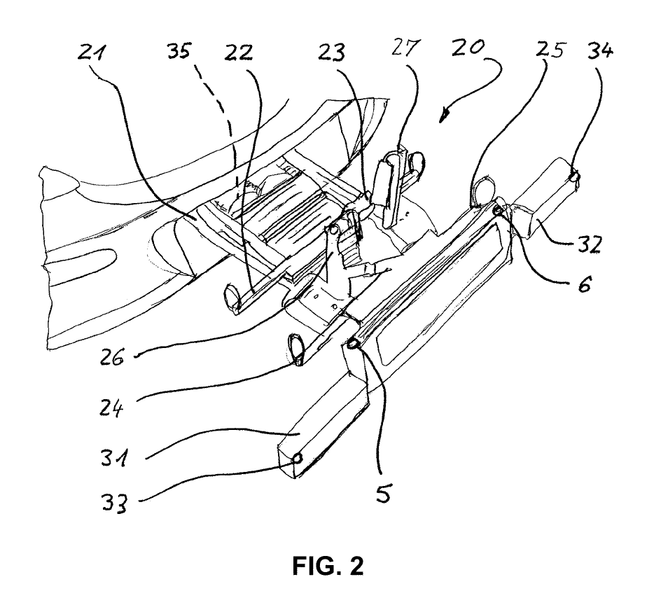

The rear spacing sensors 4 and 5 are arranged laterally to a license plate carrier 8. A carrier 9 (not visible in FIG. 1) is integrated in the vehicle rear 1. This carrier is extendable below the floor plate under the trunk closed by the rear hatch 2 in the direction of the longitudinal axis of the vehicle from its nonusage position 10 shown in FIG. 1 into a usage position (compare FIG. 2). For this purpose, the carrier 9 is provided with telescoping rails, whose fixed telescoping part is connected fixedly in a suitable way to the vehicle frame.

FIG. 2 shows the usage position 20 of the carrier 9, the guide rails or telescopic rails 21 noted being partially recognizable. The carrier is provided with multiple elements 22, 23, which are erected and/or folded up in the extended state (usage position) 20 shown, such as holders 24, 25, for one bicycle frame each, and vertically extending supports 26, 27.

Rear lights (taillights, brake lights, turn signals) are provided laterally in light units 31, 32. Spacing sensors 33, 34 of the carrier 9 are provided at the outer points of these units 31, 32.

A position sensor 35 (not shown in detail), which cooperates with the guide rails 21, for example, registers the final position of the extended carrier 9. The carrier can fundamentally also assume different final positions in multiple steps, for example, as a function of which transport material or how many bicycles are to be transported on the carrier 9. With the output of this position signal indicating the final position of the carrier 9, the spacing sensors 33, 34 are activated. In contrast, the rear spacing sensors 4, 7 are deactivated in this state. As shown in FIG. 2, it can be provided according to a particularly advantageous design that the rear spacing sensors 5, 6 are extendable together with the carrier 9, and supplement the environmental detection of the sensors 33, 34 in the position shown in FIG. 2. Otherwise—i.e., if sensors 5, 6 were situated fixed—they would advantageously also be deactivated in the usage position 20.

A rear carrier system having parking sensors in twofold system adaptation is thus implemented, mainly for the refracted position of the rear carrier shown in FIG. 1 and for the extended position of the rear carrier shown in FIG. 2, an automatic recognition of the operating state and thus an automatic activation or deactivation of the required or nonrequired spacing sensors being implemented automatically. Compact vehicles may thus be also equipped easily with a parking assistance system, without it being influenced or impaired if a rear carrier system is provided.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A baggage carrier configuration for a vehicle rear, comprising:
a carrier that is permanently connected to the vehicle and is movable relative to the vehicle rear from a nonusage position into a usage position that extends further away from the vehicle rear; and
a spacing sensor on the carrier and adapted to activate when the carrier is in the usage position.

2-8. (canceled)

9. The configuration according to claim 1, wherein the spacing sensor is situated on a rear light that is foldable outward.

10. The configuration according to claim 1, the vehicle rear is equipped with fixed a rear spacing sensor that is deactivated in the usage position of the carrier.

11. The configuration according to claim 1, wherein the spacing sensor is deactivated in the nonusage position.

12. The configuration according to claim 1, the rear spacing sensor is situated in an area of a rear license plate carrier.

13. The configuration according to claim 5, wherein the spacing sensor provided in the area of the rear license plate is movable with the carrier into the usage position.

14. The configuration according to claim 1, further comprising a position sensor that is adapted to monitor the position of the carrier relative to the vehicle rear.

15. The configuration according to claim 1, wherein the carrier is movable step-by-step into various usage positions selectable according to the transport material.

16. The configuration according to claim 1, further comprising a second spacing sensor on the carrier and that are adapted to activate when the carrier is in the usage position.

17. The configuration according to claim 1, wherein the second spacing sensor is situated on a rear light that is foldable outward.

18. The configuration according to claim 1, wherein the second spacing sensor is deactivated in the nonusage position.

19. The configuration according to claim 5, wherein the second spacing sensor provided in the area of the rear license plate is movable with the carrier into the usage position.
